(19) United States
(12) Patent Application Publication
(10) Pub. No.: US 2025/0250207 A1
(43) Pub. Date: Aug. 7, 2025

(54) TYPE OF GLASS-BASED CONCRETE AND PREPARATION METHOD THEREOF

(71) Applicant: ZHEJIANG UNIVERSITY OF TECHNOLOGY, HANGZHOU (CN)

(72) Inventors: CHUANQING FU, HANGZHOU (CN); HANYI ZHAO, HANGZHOU (CN); HAILONG YE, HANGZHOU (CN); RUSHENG QIAN, HANGZHOU (CN); LINJUN WANG, HANGZHOU (CN)

(21) Appl. No.: 18/928,760

(22) Filed: Oct. 28, 2024

(30) Foreign Application Priority Data
Feb. 6, 2024 (CN) 202410169405.1

(51) Int. Cl. C04B 30/00; C04B 14/04; C04B 14/06; C04B 14/22; C04B 22/06; C04B 22/10; C04B 40/00

(52) U.S. Cl. CPC C04B 30/00; C04B 14/048; C04B 14/068; C04B 14/22; C04B 22/06; C04B 22/10; C04B 40/0085

(57) ABSTRACT

A glass-based concrete includes in parts by mass: 25 to 35 parts of a glass material, 15 to 25 parts of fine aggregate, 33 to 45 parts of coarse aggregate, and 1 to 5 parts of a fluxing agent. A method for preparing a glass-based concrete includes steps of: S1. mixing raw materials according to the above parts by mass: 25 to 35 parts of a glass material, 15 to 25 parts of fine aggregate, 33 to 45 parts of coarse aggregate, and 1 to 5 parts of a fluxing agent; S2. putting the mixture into a high-temperature furnace, setting temperature, and heating to melt to form a uniform and bubble-free liquid glass-based concrete; and, S3. pouring the liquid glass-based concrete into a mold for cooling and molding. The glass-based concrete of the present invention is characterized by high strength, low energy consumption and low carbon emission.

### TECHNICAL FIELD OF THE INVENTION

The present invention belongs to the field of building materials, and relates to a glass-based concrete and preparation method thereof.

### BACKGROUND OF THE INVENTION

In the construction industry, the production and application of concrete as the most used artificial material in human history is very important. The conventional concrete is mainly prepared by mixing cement, water, coarse aggregate, fine aggregate and other additives. However, the conventional concrete preparation methods have some limitations, such as fixed formulation, high energy consumption, large water demand, high carbon emission (about 1 ton CO₂ emission from 1 ton cement clinker) and environmental impact. With the progress of science and technology and the enhancement of environmental awareness, it is imperative to create concrete production methods, and the demand for new concrete materials is increasing to satisfy the requirements for modern construction diversification.

On the other hand, according to statistics, in 2021, the output of waste glass in China was 22.75 million tons, and the recycling amount was 10.05 million tons, with a recycling rate of 44%, which was far less than the recycling level of above 80% in Japan, the European Union, etc. Waste glass is stable, and not easy to rot, burn or dissolve. If the waste glass is buried, lots of land resources will be occupied; and, if the waste glass is incinerated, glass substances will adhere to the wall of the incinerator, resulting in increased energy consumption and increased slag treatment cost, and bringing about a huge waste of resource and energy. In order to closely focus on the “Double Carbon” strategy, it is a new idea for green construction development to prepare concrete from waste glass. This technology aims to reduce energy consumption and carbon emission by melting waste glass to produce concrete. This technology is environmentally-friendly and beneficial to construction concrete in waterless areas, and solve the technical problem of preparing concrete construction materials under waterless conditions such as moon landing projects, so that the preparation and application scenarios of concrete are significantly expanded, and the difficulty in waste glass utilization is also solved. The research and development of this technology is of great significance for promoting the sustainable development of the construction industry.

### SUMMARY OF THE INVENTION

In order to overcome the defect that waste glass cannot be effectively utilized in the prior art, the present invention provides a glass-based concrete and preparation method thereof, which effectively utilizes waste glass. The prepared glass-based concrete is characterized by high strength, low energy consumption and low carbon emission, and is suitable for the technical situation of preparing construction concrete in waterless areas and concrete construction materials under waterless conditions such as moon landing projects.

To solve the technical problem, the present invention employs the following technical solutions.

A glass-based concrete is provided, including the following components in parts by weight: 25 to 35 parts of a glass material, 15 to 25 parts of fine aggregate, 33 to 45 parts of coarse aggregate, and 1 to 5 parts of a fluxing agent; and, the components are melted to prepare the glass-based concrete.

Further, the glass material is one or a combination of at least two or more of glass, a raw material for preparing glass, waste glass, and waste glass slag. When the waste glass or waste glass slag is used, the utilization of solid wastes of construction can be improved.

Further, the raw material for preparing glass is one or a combination of at least two or more of quartz, limestone, soda ash and feldspar. The raw material for preparing glass adopts the formulation in the prior art.

Furthermore, the fine aggregate is one or a combination of at least two or more of river sand, standard sand, machine-made sand, sea sand, washed-out sand and recycled aggregate.

Furthermore, the coarse aggregate is one or a combination of at least two or more of crushed stones, pebbles and recycled coarse aggregate.

Preferably, the fluxing agent is one or a combination of at least two or more of sodium carbonate fluxing agent, potassium carbonate fluxing agent and red lead.

By using the above technical solutions, by adding the fluxing agent, the problems of high energy consumption and carbon emission in the high-temperature melting process are avoided, and the fine aggregate and the coarse aggregate is prevented from being adversely affected at a high temperature. Moreover, this method realizes the preparation of the glass-based concrete through reasonable raw material ratio and process control.

A method for preparing a glass-based concrete is provided, including the following steps of:
S1. mixing a glass material, fine aggregate, coarse aggregate and a fluxing agent according to the following parts by mass: 25 to 35 parts of the glass material, 15 to 25 parts of the fine aggregate, 33 to 45 parts of the coarse aggregate, and 1 to 5 parts of the fluxing agent;
S2. putting the mixture into a high-temperature furnace, setting temperature, and heating to melt to form a uniform and bubble-free liquid glass-based concrete; and
S3. pouring the liquid glass-based concrete into a mold for cooling and molding.

Preferably, in the step S2, the set temperature is 600° C. to 1600° C.

The present invention mainly has the following beneficial effects.

1. By using the melting technology with a fluxing agent, the softening point of glass is lowered, energy consumption and environmental pollution are effectively reduced, and the fine aggregate and the coarse aggregate are prevented from being adversely affected at a high temperature.

2. Through accurate raw material ratio and process control, the stable preparation of molten glass and the high performance of concrete are ensured.

3. The glass-based concrete prepared by the preparation method of the present invention shows excellent properties such as high strength and low energy consumption.

### BRIEF DESCRIPTION OF THE DRAWINGS

FIG. 1 is a broken line graph of compressive strength test data of the glass-based concrete.

### DETAILED DESCRIPTION OF THE INVENTION

The present invention will be further described below with reference to the accompanying drawings.

### Embodiment 1

A glass-based concrete was prepared from the following components in parts by mass: 25 parts of glass, 15 parts of river sand, 33 parts of crushed stones, and 1 part of a fluxing agent.

The glass-based concrete in this embodiment was prepared by a method including the following steps:

1. The glass, river sand, crushed stones and the fluxing agent were mixed evenly to obtain a mixture.

2. The mixture was put into a high-temperature furnace, the temperature was set as 800° C., and the mixture was heated to melt to form a uniform and bubble-free liquid glass-based concrete.

3. The liquid glass-based concrete was poured into a mold for cooling and molding. The fluxing agent is sodium carbonate fluxing agent.

The glass material is one or a combination of at least two or more of glass, a raw material for preparing glass, waste glass, and waste glass slag. When the waste glass or waste glass slag is used, the utilization of solid wastes of construction can be improved. The raw material for preparing glass is one or a combination of at least two or more of quartz, limestone, soda ash and feldspar. The raw material for preparing glass adopts the formulation in the prior art.

The fine aggregate may also be one or a combination of at least two or more of standard sand, machine-made sand, sea sand, washed-out sand and recycled aggregate. The coarse aggregate may also be one or a combination of at least two or more of pebbles and recycled coarse aggregate.

### Embodiment 2

A glass-based concrete was prepared from the following components in parts by mass: 30 parts of glass, 20 parts of river sand, 39 parts of crushed stones, and 3 parts of a fluxing agent.

The glass-based concrete in this embodiment was prepared by a method including the following steps:

1. The glass material, river sand, crushed stones and the fluxing agent were mixed evenly to obtain a mixture.

2. The mixture was put into a high-temperature furnace, the temperature was set as 600° C., and the mixture was heated to melt to form a uniform and bubble-free liquid glass-based concrete.

3. The liquid glass-based concrete was poured into a mold for cooling and molding. The fluxing agent is a mixture of sodium carbonate fluxing agent and potassium carbonate fluxing agent.

The glass material is one or a combination of at least two or more of glass, a raw material for preparing glass, waste glass, and waste glass slag. When the waste glass or waste glass slag is used, the utilization of solid wastes of construction can be improved. The raw material for preparing glass is one or a combination of at least two or more of quartz, limestone, soda ash and feldspar. The raw material for preparing glass adopts the formulation in the prior art.

### Embodiment 3

A glass-based concrete in this embodiment was prepared from the following components in parts by mass: 35 parts of a glass material, 25 parts of river sand, 45 parts of crushed stones, and 5 part of a fluxing agent.

The glass-based concrete in this embodiment was prepared by a method including the following steps:

1. The glass, river sand, crushed stones and the fluxing agent were mixed evenly to obtain a mixture.

2. The mixture was put into a high-temperature furnace, the temperature was set as 1600° C., and the mixture was heated to melt to form a uniform and bubble-free liquid glass-based concrete.

3. The liquid glass-based concrete was poured into a mold for cooling and molding.

The fluxing agent is red lead.

The glass material is one or a combination of at least two or more of glass, a raw material for preparing glass, waste glass, and waste glass slag. When the waste glass or waste glass slag is used, the utilization of solid wastes for construction can be improved. The raw material for preparing glass is one or a combination of at least two or more of quartz, limestone, soda ash and feldspar. The raw material for preparing glass adopts the formulation in the prior art.

### Embodiment 4

The glass-based concrete in this comparative example differs from that in Embodiment 3 in that: in the preparation of the components in parts by pass, there are 30 parts of the glass material.

The rest is the same as Embodiment 3.

### Embodiment 5

The glass-based concrete in this comparative example differs from that in Embodiment 3 in that: in the preparation of the components in parts by pass, there are 25 parts of the glass material.

The rest is the same as Embodiment 3.

### Comparison Embodiment 1

The glass-based concrete in this comparative example differs from that in Embodiment 3 in that: in the preparation of the components in parts by pass, there are 20 parts of the glass material.

The rest is the same as Embodiment 3.

Performance test: the test method in the embodiments of the present invention was as follows: the glass-based concrete in Embodiments 1-5 and Comparative example 1 was prepared, and the compressive strength of the glass-based concrete was tested according to Standard for Test Method of Mechanical Properties on Concrete (GB/T50081-2019). Six test blocks were tested in each embodiment, and each concrete test block had a size of 150 mm×150 mm×150 mm. The test blocks were tested after being cooled. The arithmetic average value was calculated as the compressive strength value. The test results were shown in Table 1.

TABLE 1

| No. | Compressive strength MPa |
|---|---|
| Embodiment 1 | 123.5 |
| Embodiment 2 | 122.6 |
| Embodiment 3 | 123.1 |
| Embodiment 4 | 100.2 |
| Embodiment 5 | 90.4 |
| Comparative example 1 | 85.6 |

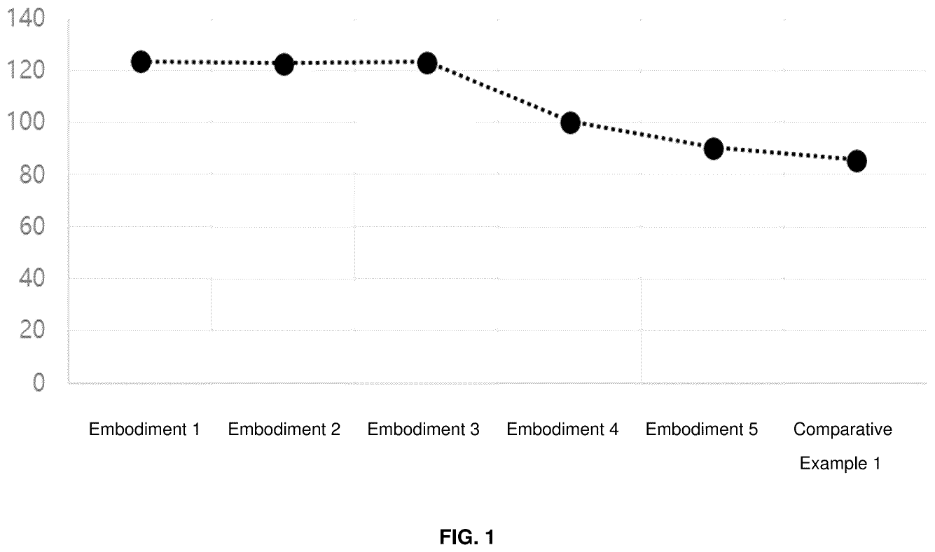

FIG. 1 is a broken line graph of compressive strength test data of the glass-based concrete in Embodiments 1-5 and Comparative example 1. It can be seen from the data in Table and FIG. 1 that, by preparing concrete from the glass material, river sand and crushed stones, a higher compressive strength can be obtained, and the production requirements can be satisfied. The comparison between Embodiment 1 and Embodiment 2 indicates that, when the mass ratio of the glass material to the river sand to the crushed stones to the fluxing agent is 25:15:33:2, it is advantageous to enhance the compressive strength of the glass-based concrete. The comparison between Embodiments 3-5 and Comparative example 1 indicates that the compressive strength of the glass-based concrete can be further improved by reasonably controlling the number of parts by mass of the glass material.

Moreover, the energy consumption is reduced in the implementation process, and the stable preparation of molten glass and the high performance of concrete are also realized. More importantly, this method effectively protects sand and coarse aggregate from performance damage due to temperature in the preparation process, and the excellent properties are fully exerted.

It is to be noted that, for simplicity of description, the above embodiments and comparative examples are all described as a series of act combinations; however, it should be understood by those skilled in that the present invention is not limited to the described act order, because some steps can be performed in other orders or simultaneously according to the present invention. Moreover, it should be understood by those skilled in the art that the embodiments described in this specification are all preferred embodiments and the involved acts and modules are not necessary for the present invention.

It should be understood by a person of ordinary skill in the art that the above description merely shows the preferred embodiments and are not intended to limit the present invention. Although the present invention has been described in detail with reference to the above embodiments, those skilled in the art can still make amendments to the technical solutions recorded in the above embodiments or make equivalent substitutions to some technical solutions. All amendments or equivalent substitutions made within the spirit and principle of the present invention shall fall into the protection scope of the present invention.

1. A glass-based concrete, comprising the following components in parts by weight: 25 to 35 parts of a glass material, 15 to 25 parts of fine aggregate, 33 to 45 parts of coarse aggregate, and 1 to 5 parts of a fluxing agent; and, the components are melted to prepare the glass-based concrete.

2. The glass-based concrete according to claim 1, wherein the glass material is one or a combination of at least two or more of glass, a raw material for preparing glass, waste glass, and waste glass slag.

3. The glass-based concrete according to claim 1, wherein the raw material for preparing glass is one or a combination of at least two or more of quartz, limestone, soda ash and feldspar.

4. The glass-based concrete according to claim 1, wherein the fine aggregate is one or a combination of at least two or more of river sand, standard sand, machine-made sand, sea sand, washed-out sand and recycled aggregate.

5. The glass-based concrete according to claim 1, wherein the coarse aggregate is one or a combination of at least two or more of crushed stones, pebbles and recycled coarse aggregate.

6. The glass-based concrete according to claim 1, wherein the fluxing agent is one or a combination of at least two or more of sodium carbonate fluxing agent, potassium carbonate fluxing agent and red lead.

7. A method for preparing the glass-based concrete according to claim 1, comprising the following steps of:
S1: mixing a glass material, fine aggregate, coarse aggregate and a fluxing agent according to the following parts by mass: 25 to 35 parts of the glass material, 15 to 25 parts of the fine aggregate, 33 to 45 parts of the coarse aggregate, and 1 to 5 parts of the fluxing agent;
S2: putting the mixture into a high-temperature furnace, setting temperature, and heating to melt to form a uniform and bubble-free liquid glass-based concrete; and
S3: pouring the liquid glass-based concrete into a mold for cooling and molding.

8. The preparation according to claim 1, wherein, in the step S2, the set pressure is 600° C. to 1600° C.

9. The glass-based concrete according to claim 2, wherein the raw material for preparing glass is one or a combination of at least two or more of quartz, limestone, soda ash and feldspar.

10. The glass-based concrete according to claim 2, wherein the fine aggregate is one or a combination of at least two or more of river sand, standard sand, machine-made sand, sea sand, washed-out sand and recycled aggregate.

11. The glass-based concrete according to claim 2, wherein the coarse aggregate is one or a combination of at least two or more of crushed stones, pebbles and recycled coarse aggregate.

12. The glass-based concrete according to claim 2, wherein the fluxing agent is one or a combination of at least two or more of sodium carbonate fluxing agent, potassium carbonate fluxing agent and red lead.
